(19) United States
(12) Patent Application Publication
(10) Pub. No.: US 2007/0248777 A1
(43) Pub. Date: Oct. 25, 2007

(54) Anti-Cracking Heat Shrinkable Polyester Film

(75) Inventors: Jung-Gyu Lee, Anyang-si (KR); Nam-Il Kim, Suwon-si (KR); Sang-Il Kim, Suwon-si (KR); Yong-Won Kim, Suwon-si (KR)

Correspondence Address: ANDERSON, KILL & OLICK, P.C., 1251 AVENUE OF THE AMERICAS, NEW YORK,, NY, 10020-1182, US

(73) Assignee: SKC Co., Ltd., Kyungki-do (KR)

(21) Appl. No.: 11/630,024

(22) PCT Filed: Jun. 17, 2005
(86) PCT No.: PCT/KR05/01871

§ 371 Date: Dec. 18, 2006

(30) Foreign Application Priority Data
Jun. 18, 2004 (KR) 10-2004-0045480

(51) Int. Cl. B65D 23/08; B32B 27/36

(52) U.S. Cl. 428/34.1; 428/221

(57) ABSTRACT

A heat-shrinkable polyester film comprising styrene acrylic polymer in an amount ranging from 0.05 to 5% by weight based on the total weight of the film together with 2,2-dimethyl(−1,3-propane)diol-copolymerized polyester and polytrimethylene terephthalate exhibits superior properties suitable for labeling or shrink-wrapping containers.

### FIELD OF THE INVENTION

The present invention is directed to a heat-shrinkable polyester film having improved impact-resistance in the direction perpendicular to the direction of main shrinkage, which is suitable for labeling or shrink-wrapping containers.

### BACKGROUND OF THE INVENTION

Heat shrinkable films have been extensively used, e.g., for labeling bottles, batteries or electrolytic condensers, and for wrapping containers and other products. Such heat-shrinkable films are formed of polyvinyl chloride, polystyrene or polyester, and they are required to have good sealing and shrinking properties as well as good heat resistance, chemical resistance, weatherability and printability.

Conventional heat-shrinkable films formed of polyvinyl chloride or polystyrene have relatively poor heat resistance, chemical resistance, weather resistance and heat-shrinking properties. In particular, polyvinyl chloride films have recently become increasingly disfavored because they emit toxic pollutants on combustion. Polystyrene films, on the other hand, have the problem of poor printability, requiring the use of a special purpose ink. Polystyrene films tend to undergo shrinkage by themselves during long-term storage.

Heat-shrinkable polyester films formed of polyethylene terephthalate (PET) have satisfactory heat resistance, chemical resistance, weatherability and shrinking properties. However, the shrinkage stress and shrinkage ratio of a PET film are generally unacceptably high, giving non-uniform shrinkage with consequential distortion of images printed thereon.

Japanese Laid-open Patent Publication Nos. 1999-0068230, 1999-0088005, 2000-0076618, 2001-0078083, 2002-0018594 and 2003-0030099 disclose that the shrinkage uniformity of a PET film can be improved by blending a polyethylene terephtalate with polybuthylene terephthalate in a particular ratio, or by copolymerizing a dicarboxylic acid component such as terephthalic acid and isophthalic acid with a diol component such as ethylene glycol and 1,4-cyclohexanedimethanol.

Although this heat-shrinkable film shows some improvement in terms of uniform shrinkage, it is easily ruptured by external impact since the mechanical property of the heat-shrinked film in the direction perpendicular to the main shrinking direction is not satisfactory.

### SUMMARY OF THE INVENTION

Accordingly, it is an object of the present invention to provide a heat-shrinkable polyester film having a good impact-resistance even after thermally shrunk for labeling or shrink-wrapping containers.

In accordance with the present invention, there is provided a heat-shrinkable polyester film comprising a 2,2-dimethyl(−1,3-propane)diol-copolymerized polyester and a polytrimethylene terephthalate as major components; and a styrene acrylic polymer in an amount ranging from 0.05 to 5% by weight based on the total weight of the film.

### DETAILED DESCRIPTION OF THE INVENTION

The heat-shrinkable polyester film in accordance with the present invention is characterized by comprising a styrene acrylic polymer in an amount ranging from 0.05 to 5% by weight based on the total weight of the film, together with a 2,2-dimethyl(−1,3-propane)diol-copolymerized polyester and a polytrimethylene terephthalate.

The inventive polyester film is not easily ruptured by external impact even when provided around containers as labels, for its tensile strength and elongation in the direction perpendicular to the main shrinking direction after thermal shrink treatment are markedly improved over the styrene acrylic polymer. Among the longitudinal and transverse directions, the direction having a greater thermal shrinkage ratio is set as the main shrinking direction. When the amount of styrene acrylic polymer is less than 0.05% by weight, the impact-resistance may be less satisfactory; and when more than 5% by weight, poor printability may result.

The 2,2-dimethyl(−1,3-propane)diol-copolymerized polyester used in the present invention may be prepared by copolymerizing a dicarboxylic acid component such as terephthalic acid or dimethyl terephthalate with a diol component such as ethylene glycol or 2,2-dimethyl(−1,3-propane)diol, as described in Korean Patent Publication No. 2002-73307; and preferably comprises 75 to 85% by mole of ethylene terephthalate repeating unit and 15 to 25% by mole of 2,2-dimethyl(−1,3-propylene)terephthalate repeating unit.

In addition, the polytrimethylene terephthalate used in the present invention may be prepared by copolymerizing a dicarboxylic acid component such as dimethyl terephthalate with a mixture of diol components such as propanediol, 2,2-dimethyl(−1,3-propane)diol and ethylene glycol, as described in Korean Patent Publication No. 2002-73305. The dicarboxylic acid component may further comprise dimethyl isophthalate and dimethyl-2,6-naphthalenedicarboxylate, and preferably comprises 20% or less by mole of dimethyl isophthalate, 10% or less by mole of dimethyl-2,6-naphthalenedicarboxylate and 70 to 100% by mole of dimethyl terephthalate; and the diol component preferably comprises 5 to 20% by mole of 2,2-dimethyl(−1,3-propane)diol, 5 to 20% by mole of propanediol and 60 to 90% by mole of ethylene glycol.

In the inventive polyester film, it is preferable to use 2,2-dimethyl(−1,3-propane)diol-copolymerized polyester and polytrimethylene terephthalate having an intrinsic viscosity of 0.5 to 0.8 and 0.7 to 0.95, respectively.

The inventive polyester film preferably comprises the 2,2-dimethyl(−1,3-propane)diol-copolymerized polyester and polytrimethylene terephthalate in amounts of 75 to 94% by weight and 5 to 20% by weight, respectively, based on the total weight of the film.

Also, the styrene acrylic polymer used in the present invention may be prepared by the conventional method or is commercially available; it is preferable to use the styrene acrylic polymer having a number-average molecular weight (Mn) of 3,000 or less, and 4 or more epoxy groups per polymer chain; and representative examples thereof include multi-functional polymers (Johnson Polymer Co., U.S.A).

The inventive film comprises the styrene acrylic polymer in an amount of 0.05 to 5% by weight based on the total weight of the film.

The styrene acrylic polymer in the above amount enhances affinities between the polymeric components of the inventive film to prevent gelation and to improve mechanical properties in the direction perpendicular to the drawing direction during the drawing process, as well as the limiting viscosity of the resulting film.

The polyester film according to the present invention may further comprise other components such as a polycondensation catalyst, dispersant, electrostatic generator, antistatic agent, antiblocking agent, inorganic lubricant, etc., in amounts that would not adversely affect the film properties.

The inventive polyester film may be formed by an extrusion or calendaring process. Specifically, the inventive film may be formed by melt-extruding the polymer composition comprising said 2,2-dimethyl(−1,3-propane)diol-copolymerized polyester, polytrimethylene terephthalate and styrene acrylic polymer at a temperature ranging from 240 to 320° C. to obtain a molten sheet, cooling and solidifying the molten sheet, and uniaxially drawing the solidified sheet in the transverse direction with a tenter at a temperature greater than Tg of the undrawn sheet. Also, if necessary, the drawing process may be performed in both transverse and longitudinal directions. In the drawing process, the undrawn sheet is preferably drawn 3.0 to 7.0 times, more preferably, 3.5 to 4.5 times in the transverse direction to achieve a desirable thermal shrinkage ratio.

The thickness of the inventive heat-shrinkable film may be preferably in the range of 12 to 125 μm, when used for labels.

The heat-shrinkable polyester film according to the present invention shows a defect rate of 20% or less when subjected by an external impact test as described in Performance Test of Example.

The inventive heat-shrinkable polyester film has a thermal shrinkage ratio of 50% or more in the main shrinking direction when treated at 90° C. for 10 seconds. Also, the inventive film has a tensile strength and elongation at rupture in the direction perpendicular to the main shrinking direction of 3 kg·f/mm² or more and 100% or more, respectively, after being shrunk by about 30%, e.g., by treatment at 90° C. for about 5 seconds. When the tensile strength is less than 3 kg·f/mm² or the elongation is less than 100%, the resultant film provided around a container as a label is easily ruptured by an external impact, e.g., during transportation.

The conventional heat-shrinkable polyester film which is shrinkable in one direction (drawing direction) has problems in that mechanical properties in the direction perpendicular to the drawing direction are undesirably low. Although mechanical properties of a polyester film may be improved in both the longitudinal and transverse directions by performing biaxially drawing process, the resultant film is not suitable for a shrinkable label film.

The inventive heat-shrinkable polyester film, on the other hand, has good mechanical properties in the direction perpendicular to the drawing direction even when uniaxially drawn, and thus, it can be advantageously used for labeling or shrink-wrapping containers, particularly glass bottles.

The present invention is further described and illustrated in Examples, which are, however, not intended to limit the scope of the present invention.

### PREPARATION EXAMPLE 1

### Preparation of 2,2-dimethyl(−1,3-propane)diol Copolymerized Polyester (Polymer A)

100 parts by mole of dimethyl terephthalate, 130 parts by mole of ethylene glycol and 30 parts by mole of 2,2-dimethyl(−1,3-propane)diol were placed in an autoclave equipped with a distillation column, and manganese acetate (an interesterification catalyst) was added thereto in an amount of 0.07% by weight based on the weight of dimethyl terephthalate. While removing methanol formed during the reaction, the temperature was raised to 220° C. After the interesterification was complete, trimethyl phosphate (a stabilizer) was added in an amount of 0.4% by weight based on the weight of dimethyl terephtalalte, and silicon dioxide having an average particle diameter of 0.28 μm (an antiblocking agent), in an amount of 0.07% by weight based on the amount of dimethyl terephthalate. After 5 minutes, antimonytrioxide and tetrabutylene titanate (polymerization catalyst) were added in amounts of 0.035% by weight and 0.005% by weight, respectively, based on the weight of dimethyl terephthalte, and the resulting mixture was transferred to a second reactor equipped with a vacuum unit, and allowed to react at 285° C. for about 210 minutes, to obtain 2,2-dimethyl(−1,3-propane)diol copolymerized polyester having an intrinsic viscosity of 0.68.

### PREPARATION EXAMPLE 2

### Preparation of polytrimethylene terephthalate (Polymer B

100 parts by mole of dimethyl terephthalate and 140 parts by mole of 1,3-propanediol were placed in an autoclave equipped with a distillation column, and tetrabutylene titanate (an interesterification catalyst) was added thereto in an amount of 0.05 % by weight based on the weight of dimethyl terephthalate.

While removing methanol formed during the reaction, the temperature was raised to 220° C. After the interesterification was complete, trimethyl phosphate (a stabilizer) was added in an amount of 0.045% by weight based on the weight of dimethyl terephtalalte. After 10 minutes, antimonytrioxide (polymerization catalyst) was added in an amount of 0.02% by weight based on the weight of dimethyl terephthalte, and the resulting mixture was transferred to a second reactor equipped with a vacuum unit, and allowed to react at 270° C. for about 180 min, to obtain polytrimethylene terephthalate having an intrinsic viscosity of 0.86.

### PREPARATION EXAMPLE 3

### Preparation of Styrene Acrylic Polymer-Containing Copolymerized Polyester (Polymer C)

The procedure of Preparation Example 1 was repeated except that styrene acrylic polymer ADR-4367® (Johnson Polymer Co.) flake was further added in an amount of 1% by weight based on the amount of dimethyl terephthalate after the interesterification was completed, to obtain styrene acrylic polymer-containing copolymerized polyester having an intrinsic viscosity of 0.80.

### EXAMPLES 1 TO 4 AND COMPARATIVE EXAMPLES 1 TO 4

The polymers A, B and C were mixed in various ratios as shown in Table 1, and each mixture was melted at 290° C., extruded through a T-die, and cooled by a casting roller maintained at 20° C., to obtain an undrawn sheet having Tg as shown in Table 1. The undrawn sheet was preheated to a prescribed temperature as shown in Table 1 for 5 seconds, drawn at a draw ratio of 4.0 in the transverse direction, to obtain a uiaxially drawn polyester film of 50 micron thickness. The drawing temperatures are also shown in Table 1.

TABLE 1

| | Amount of | | | | | |
|---|---|---|---|---|---|---|
| | polymer | | | | | |
| | (% by | | | Tg of the | Preheating | Drawing |
| | weight) | | | undrawn sheet | temp. | temp. |
| Exam. No. | (A) | (B) | (C) | (° C.) | (° C.) | (° C.) |
| 1 | 80 | 10 | 10 | 72 | 85 | 78 |
| 2 | 70 | 10 | 20 | 72 | 85 | 78 |
| 3 | 60 | 10 | 30 | 72 | 85 | 78 |
| 4 | 50 | 10 | 40 | 72 | 85 | 78 |
| Com. Ex. 1 | 100 | 0 | 0 | 75 | 88 | 81 |
| Com. Ex. 2 | 90 | 10 | 0 | 72 | 85 | 78 |
| Com. Ex. 3 | 87 | 10 | 3 | 72 | 85 | 78 |
| Com. Ex. 4 | 97 | 0 | 3 | 75 | 88 | 81 |

(A) 2,2-dimethyl-1,3-propanediol copolymerized polyester
(B) polytrimethylene terephthalate
(C) styrene acrylic polymer-containing copolymerized polyester

Performance Test

The polyester films manufactured in Examples 1 through 4 and Comparative Examples 1 through 4 were examined for the following properties.

(1) Thermal Shrinkage Ratio

A film sample was cut into a 15 mm (width)×300 mm (length) piece, put in water of a prescribed temperature for 10 seconds, and the length (L) of the piece after the thermal treatment was measured, to determine the thermal shrinkage ratio in the transverse direction (main shrinking direction) by the following formula:
Thermal shrinkage ratio (%)=[(300−L)/300]×100
(2) Tensile Strength and Elongation

A 5 cm (the direction perpendicular to the main shrinking direction)×15 mm (the main shrinking direction) film specimen was held with clips arranged at a 5 cm interval, subjected to a tensile test using a tensile test apparatus (Model 6021, manufactured by Instron Co.), and the tensile strength kg·f/mm²) and elongation (%) at rupture in the longitudinal direction (the direction perpendicular to the main shrinking direction) were measured.

(3) External Impact-Resistance

330 milliliter coca-cola glass bottles were thoroughly covered with a test film using a shrink tunnel, and 24 such covered test bottles were placed in a cardboard box in a 4 rows by 6 columns configuration at 5 mm intervals, and the box was sealed. Then, the box was vibrated horizontally for 30 minutes with a vibration-amplitude of 50 mm and a vibration-speed of 180 shuttles/min, and the impact-resistance was evaluated by measuring the rupture defective proportion (%) by visual inspection. The rupture defective proportion (%) represents the percentage of the bottles having a rupture-length of 30 mm or more.

(4) Mechanical Properties After Being Shrunk by 30%.

A label having a cylindrical form (circumference: 408.2 mm, height: 300 mm) was produced using a test film, wrapped around a cylindrical container (circumference: 314 mm, height: 310 mm), and passed through a steam tunnel maintained at 90° C. in a passage time of 5 seconds, to allow the film to shrink around the container by 30%. 90° C.-water was poured into the container, the water-filled container was immersed in a 90° C. bath for 30 minutes, and the label was separated from the container to be subjected to a tensile test as described in performance test (2).

The measured properties of the polyester films are shown in Table 2.

TABLE 2

| | Thermal shrinkage | | | Pre-shrinkage state | | Post-shrinkage state | | Defective |
|---|---|---|---|---|---|---|---|---|
| Exam. | ratio (%) | | | Strength | Elongation | Strength | Elongation | proportion |
| No. | 70° C. | 80° C. | 90° C. | (kgf/mm²) | (%) | (kgf/mm²) | (%) | (%) |
| 1 | 35 | 70 | 75 | 6.0 | 550 | 5.0 | 430 | 14 |
| 2 | 34 | 70 | 75 | 6.3 | 580 | 5.2 | 480 | 10 |
| 3 | 34 | 69 | 75 | 6.7 | 600 | 5.5 | 500 | 8 |
| 4 | 32 | 69 | 75 | 7.2 | 650 | 6.0 | 540 | 3 |
| Com. | 43 | 71 | 75 | 5.5 | 500 | 2.1 | Untestable | 85 |
| Ex. 1 | | | | | | | | |
| Com. | 35 | 70 | 75 | 5.8 | 530 | 1.3 | Untestable | 82 |
| Ex. 2 | | | | | | | | |
| Com. | 36 | 70 | 75 | 6.0 | 550 | 2.0 | Untestable | 75 |
| Ex. 3 | | | | | | | | |
| Com. | 42 | 71 | 74 | 5.5 | 520 | 1.8 | Untestable | 78 |
| Ex. 4 | | | | | | | | |

As shown in Table 2, the films of Examples 1 through 5 show improved properties in terms of impact-resistance (defective proportion), mechanical properties such as tensile strength and elongation in the direction perpendicular to the main shrinking direction at the pre- or post shrinkage state, as compared with those of Comparative Examples 1 through 4. Specifically, the tensile strength and elongation of the films of Examples 1 to 4 in the direction perpendicular to the main shrinking direction were 5 kg·f/mm² or more and 400% or more, respectively, even after thermally shrunk.

While the invention has been described with respect to the above specific embodiments, it should be recognized that various modifications and changes may be made to the invention by those skilled in the art which also fall within the scope of the invention as defined by the appended claims.

What is claimed is:

1. A heat-shrinkable polyester film comprising a 2,2-dimethyl(−1,3-propane)diol-copolymerized polyester and a polytrimethylene terephthalate as major components; and a styrene acrylic polymer in an amount ranging from 0.05 to 5% by weight based on the total weight of the film.

2. The heat-shrinkable polyester film of claim 1, wherein the amounts of the 2,2-dimethyl(−1,3-propane)diol-copolymerized polyester and polytrimethylene terephthalate are in the ranges of 75 to 94% by weight and 5 to 20% by weight, respectively, based on the total weight of the film.

3. The heat-shrinkable polyester film of claim 1, wherein the styrene acrylic polymer has a number-average molecular weight (Mn) of 3,000 or less, and 4 or more epoxy groups per polymer chain.

4. The heat-shrinkable polyester film of claim 1, which has a tensile strength at rupture of at least 3 kg—f/mm² and an elongation at rupture of at least 100% in the direction perpendicular to the main shrinking direction after being shrunk by 30%.

5. The heat-shrinkable polyester film of claim 1, which has a thermal shrinkage ratio of 50% or more in the main shrinking direction after being treated at 90° C. for 10 seconds.

6. The heat-shrinkable polyester film of claim 1, which has a rupture-defective proportion of 20% or less when subjected to an external impact-resistance test in the form of a label wrapped around a glass bottle.

7. The heat-shrinkable polyester film of claim 6, wherein the external impact-resistance test is performed by placing glass bottles wrapped with labels in a box at 5 mm intervals, vibrating the box horizontally for 30 minutes with a vibration-amplitude of 50 mm and a vibration-speed of 180 shuttles/min., and measuring the percentage of bottles having a rupture-length of at least 30 mm.

8. A glass bottle labeled with the heat-shrinkable polyester film of claim 1.
